(19) United States
(12) Patent Application Publication
(10) Pub. No.: US 2019/0066567 A1
(43) Pub. Date: Feb. 28, 2019

(54) INTEGRATED DISPLAY SYSTEM

(71) Applicant: Ignis Innovation Inc., Waterloo (CA)

(72) Inventors: Gholamreza Chaji, Waterloo (CA); Yaser Azizi, Waterloo (CA)

(21) Appl. No.: 16/176,175

(22) Filed: Oct. 31, 2018

Related U.S. Application Data
(63) Continuation of application No. 14/961,983, filed on Dec. 8, 2015, now Pat. No. 10,134,325.
(60) Provisional application No. 62/106,980, filed on Jan. 23, 2015.
(60) Provisional application No. 62/095,339, filed on Dec. 22, 2014.

(30) Foreign Application Priority Data
Dec. 8, 2014 (CA) 2873476

(51) Int. Cl. G09G 3/20; G09G 3/3233; G09G 3/3258

(52) U.S. Cl. CPC G09G 3/2011; G09G 3/2022; G09G 3/2096; G09G 3/3233; G09G 3/3258; G09G 3/2014; G09G 2300/0857; G09G 2300/0828; G09G 2310/08; G09G 2320/064; G09G 2330/021; G09G 2330/12; G09G 2360/12; G09G 2310/0286

(57) ABSTRACT

What is disclosed are systems and methods for emissive display systems constructed on integrated architecture platforms, for which the pixels are smart and can behave differently under different conditions to save power, provide better image quality, and/or conserve their value to reduce the power consumption associated with programming.

### CROSS REFERENCE TO RELATED APPLICATION

This application claims priority to U.S. Provisional Application No. 62/106,980, filed Jan. 23, 2015, U.S. Provisional Application No. 62/095339, filed Dec. 22, 2014, and Canadian Application No. 2,873,476, filed Dec. 8, 2014, each of which are hereby incorporated by reference herein in its entirety.

### FIELD OF THE INVENTION

This invention relates to techniques for emissive display systems constructed on integrated architecture platforms.

### BRIEF SUMMARY

According to a first aspect there is provided a display system comprising: a plurality of pixels each capable of at least a first mode of operation and a second mode of operation, each pixel comprising: a digital memory for storing data comprising greyscale data for display by the pixel; and a controller operative to allow storage of incoming data to the digital memory in the first mode of operation and to preserve data in the digital memory in the second mode of operation.

In some embodiments, the plurality of pixels are arranged into at least one row, wherein each digital memory comprises a shift register, and wherein a plurality of shift registers of pixels in the at least one row are chained together into a shift register chain, wherein incoming data loaded to the shift register chain includes only data for pixels in the first mode of operation, and wherein controllers of pixels in the second mode of operation cause the incoming data to bypass the pixels in the second mode of operation.

In some embodiments, each pixel comprises a light-emitting device and a light-emitting device driver, wherein during a time of a frame the light-emitting device driver drives the light-emitting device for a total time determined by the data in the digital memory of the pixel.

In some embodiments, during a frame, the light-emitting device driver of each pixel drives the light-emitting device of the pixel in one state prior to a counter equaling a greyscale value corresponding to the greyscale data stored in the digital memory of the pixel and drives the light-emitting device in a second state subsequent to the counter equaling the greyscale value.

In some embodiments, during a frame, for each bit of the greyscale data stored in each pixel, the light-emitting device driver of the pixel drives the light-emitting device of the pixel in one of an on-state and an off-state corresponding to a value of the bit for a time period corresponding to a weight of the bit, the light-emitting device driver driving the light emitting-device in accordance with time division clock signals.

In some embodiments, each pixel comprises a light-emitting device and a light-emitting device driver, wherein during a time of a frame the light-emitting device driver drives the light-emitting device at one of a plurality of driving force levels, and wherein under an operating condition of the pixel at least one of the driving force levels is utilized to drive the light-emitting device for a total time determined by the data in the digital memory of the pixel.

In some embodiments, the digital memory is operative for storing data comprising first greyscale data and second greyscale data, wherein the controller is operative to allow storage of incoming data comprising incoming first greyscale data simultaneously with the pixel's displaying of the second greyscale data.

In some embodiments, each pixel comprises an enable digital memory for storing a value determining one of the first mode of operation or the second mode of operation for the pixel.

In some embodiments, each greyscale bit of the incoming data are loaded into the digital memory of pixels in a row and displayed prior to a loading of a next greyscale bit.

In some embodiments, the shift register of each pixel comprises a rotating shift register.

In some embodiments, the light-emitting device driver drives the light-emitting device at a driving force based upon at least one of a peak brightness condition, a weight of a bit of the greyscale data being displayed, and a group of bits of the greyscale data.

In some embodiments, the light-emitting device driver drives the light-emitting device with use of at least one of a plurality of bias voltages and a plurality of current sources.

In some embodiments, the light-emitting device driver comprises a multiplexer with weighted select line timing for programming and retrieving data from the digital memory which comprises latches.

In some embodiments, each pixel is capable of a high dynamic range mode for which the pixel may be driven at one of a plurality of different biasing points in accordance with one of a plurality of biasing conditions for that pixel.

In some embodiments, the counter is non-linear in accordance with a gamma curve.

In some embodiments, each pixel is capable of a further test mode of operation and comprises a test circuit to control driving of the light-emitting device, wherein when the pixel is in test mode the test circuit drives the light-emitting device independent of the digital memory.

In some embodiments, each pixel is capable of a low power mode for which the greyscale data for display by the pixel constitutes a subportion of a total greyscale data stored in the digital memory.

In some embodiments, the weight of each bit of the greyscale data is assigned dynamically.

In some embodiments, the time division clock is passed from an originating pixel row to a receiving pixel row including a delay to synchronize the time division clock received by the receiving pixel row with an end of programming of the receiving pixel row.

In some embodiments, each weight of each greyscale bit corresponds to the bit order i of the greyscale bit, and the time period corresponding to a bit of weight i is proportional to 2′.

According to a second aspect there is provided a method of driving a display, the method comprising: determining for each pixel of a plurality of pixels of the display, each pixel comprising a digital memory and a controller, a current mode of operation being one of at least a first mode of operation and a second mode of operation; storing with use of the controller, incoming data comprising grey scale data in the digital memory, when the current mode of operation is determined to be the first mode of operation; and preserving greyscale data in the digital memory, when the current mode of operation is determined to be the second mode of operation.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a diagrammatic illustration of a monolithic display system architecture.

FIG. 2 is a schematic diagram of a first example of a data path between a video interface and pixel memory.

FIG. 3 is a schematic diagram of a second example of a data path between a video interface and pixel memory.

FIG. 4 is a diagrammatic illustration of an in-pixel driving element.

FIG. 5 is a timing diagram of one example of distributing a time division clock among rows.

FIG. 6 is a timing diagram of another example of distributing a time division clock among rows, using faster programming.

FIG. 7 is a timing diagram of a further example of distributing a time division clock among rows, using black sub-frames for programming.

FIG. 8 is a timing diagram of a yet another example of distributing a time division clock among rows, using double storage elements in the pixels.

FIG. 9A is a block diagram of storage elements for enable signals for multiple pixels.

FIG. 9B is a timing diagram of pixel-based addressing based on storage elements for enable signals.

FIG. 10 is a timing diagram for an exemplary driving scheme for in-pixel drivers.

FIG. 11 is a schematic diagram of a mux-based pixel circuit.

FIG. 12 is a schematic diagram of a testing display.

FIG. 13 is a schematic diagram of a display test using a time division controller to connect a pixel in a test mode.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

### Smart-Pixel Display Architecture

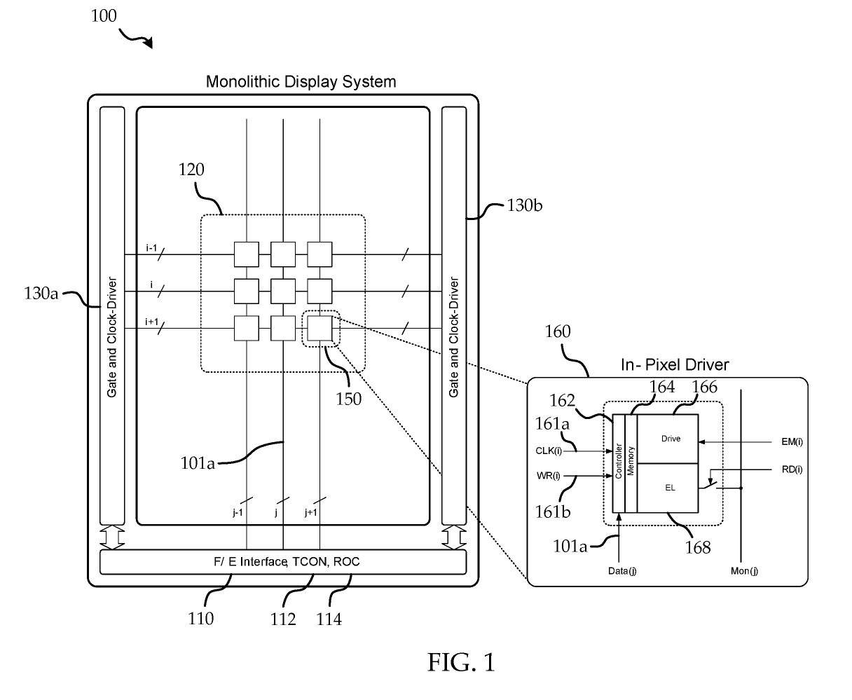

A display system 100 with monolithic architecture is illustrated in FIG. 1. This architecture is constructed of a front-end interface 110, Gate and Clock-Drivers 130a, 130b, and in-pixel driving elements 160.

The front-end (F/E) interface 110 can include a timing controller (TCON) 112 and readout circuitry (ROC) 114 and/or a data driver. The front-end 110 further networks with an array 120 of in-pixel driver 160 elements and gate/clock-drivers 130a, 130b. The gate/clock-drivers 130a, 130b provide control and clock signals to rows of pixel 150 elements. Each in-pixel driver 160 element is composed of a controller 162, memory 164, current/voltage driver 166, and a light-emitting device (EL) 168.

The controller 162 within each pixel element 150 supervises the flow of data in the memory 164 devices based on the command signals on the WR (write) 161b and CLK (clock) 161a lines.

All the loading operations explained herein can be applied to other structures in this document, and also other possible structures not explained in this document. In addition, one can take features of one method and mix it with other methods. The examples here are for demonstration and are not exhaustive of all possible cases.

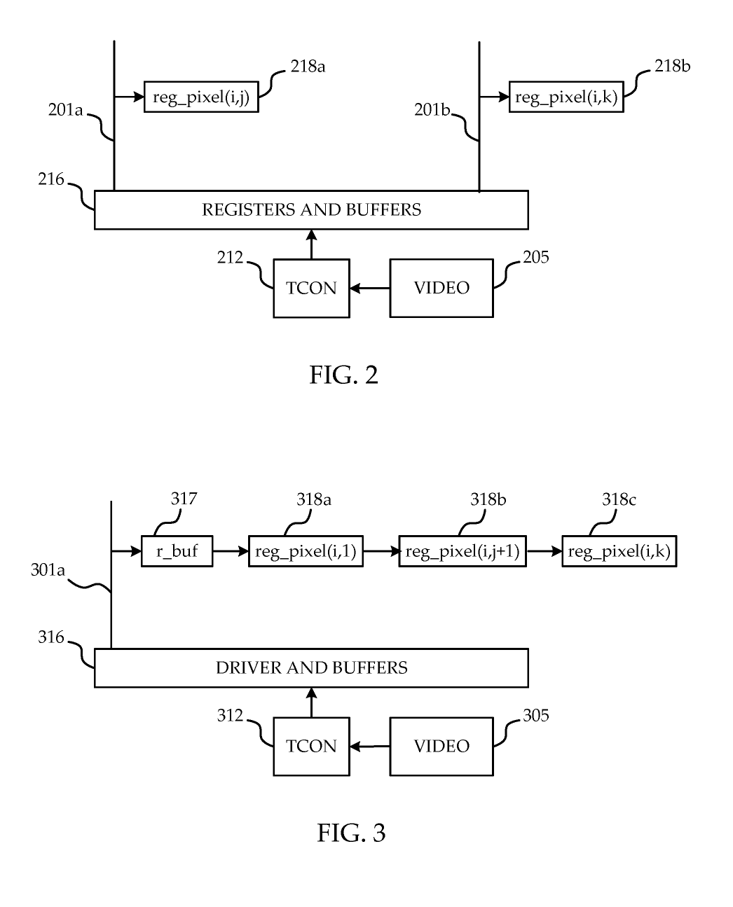

Referring now also to FIG. 2, in one aspect of the invention, the data received from the video interface 205 is stored in registers 216, connected to the columns lines 201a, 201b. Then the data is loaded from these registers 216 into the pixels in parallel or serially. In FIG. 2, the column lines 201a, 201b can be multi-bit to transfer more data during each clock.

In another aspect of the invention, the data is stored in said registers 216 partially and then the partially loaded data is transferred to the pixel in parallel or serially. In this case, the registers 216 at the boundary of the display will have fewer bits compared to the total amount of row data. In one example, if the registers 216 only store one bit for each pixel and if the row has 240×3 pixels, the total bits for the boundary registers would be 720 instead of 720 xdata_width (where data_width is the number of bits for gray scales, e.g. 8 bits). Here, the first bit of each pixel is loaded into the boundary registers 216, and thereafter the data is transferred to the respective pixel memory (reg_pixel) 218a, 218b. This operation continues until all of the data is loaded into the pixels of the row, and then is repeated for the next row. The operation can load the first bit of the data for the entire row (or column or entire display) and then move to the next bit. In this case, the display (or row) can be turned on after each bit and then the next bit can be loaded the display turned on for the time associated with that bit and then the process can be repeated for subsequent bits. The ON time of the pixel will be defined based on the weight of each bit loaded into the row (or display).

In another aspect of the invention, the data is directly loaded into the pixel memory from the video interface (FIG. 3). Here, the pixel memories 318a, . . . 318c in a row form one or more shift register chains during the programming time, and the data from the interface 205 is loaded into the shift registers without the need for serial to parallel processing.

Here, the register buffer r_buf 317 can include a switch that disconnects the data line 301a form the rows that are not selected for programming. Also, the register buffer 317 can have some conversion functionality such as converting low voltage differential signals to normal swing signals. Also, the driver and buffer 316 can do part or all of the conversion and so the register buffer block 317 does the remaining part.

In order to avoid reprogramming the pixels 150 during each frame if their data are not different from previously programmed data, a controller 162 is included in each pixel. Here an independent signal through this controller 162 can enable or disable pixel programming. In one example, to reduce the number of the signals, the data can begin with some value that tells the controller to enable or disable the programming. For example, the first bit can identify the programming mode of the pixel 150, for example reprogramming mode or halt mode. If the pixel is in reprogramming mode, the data will be saved in the shift register. If the pixel is in halt mode (i.e. retaining its previous data), the data in the shift register is not updated. As a result, the data for that pixel can stay as it is and so no refreshing power consumption will be associated with that pixel circuit while it is in halt mode.

In a case where the data is loaded through the row shift register, the data can be first loaded to the controller 162 to define the operation of each pixel and then the data is loaded to the shift register chain formed by pixel memories 164. If a pixel does not need to be reprogrammed, the controller 162 can bypass it in the shift register chain, passing the data on to the next pixel's shift register. In such a case the data passed along the chain will only contain that for pixels which are to be reprogrammed, the pixel data associated with pixels not being updated having been removed for example by TCON 112.

The drive element 166 in the pixel can be a fixed current/voltage or it can be changed depending on the display operation conditions and/or depending on the weight of the bit applied to the pixel. One example of a display operation is peak brightness. In this case, if the pixel brightness increases, the driving force of the pixel can increase to accommodate the peak brightness without losing digital grey levels. In another case, the driving force of the pixel is adjusted based on the weight of the bit applied to it. In another case, the pixel driving force is adjusted based on a group of the bits.

In one example, the pixel operation condition changes to adjust the drive force. For example, the bias condition of the driver 166 can be adjusted to either apply higher voltage or higher current to the emissive device 168 when needed. In another case, multiple drivers 166 with different strength exist in the pixel. Each of these driver elements 166 is controlled by different bits of grayscales or they are controlled by global signals based on display performance requirements.

### In-Pixel Driving Element (Pixel Driver)

The in-pixel driving element 166 (pixel driver) can be either a voltage based driver or a current based driver. In case of a voltage driver, a simple switch can connect the voltage to the emissive device (light-emitting device). This can be one switch connected to a controllable/fixed voltage bias or multiple switches connected to multiple bias voltages.

In another example, the pixel driver 166 is a current driver. Here, the gray scale bits control the strength of the current output of the pixel driver 166; or control the connection of the pixel driver 166 to the emissive device 168; or it enables/disables the current driver 166. In another example, one can mix the three operational modes to take advantage of best characteristics of each of them.

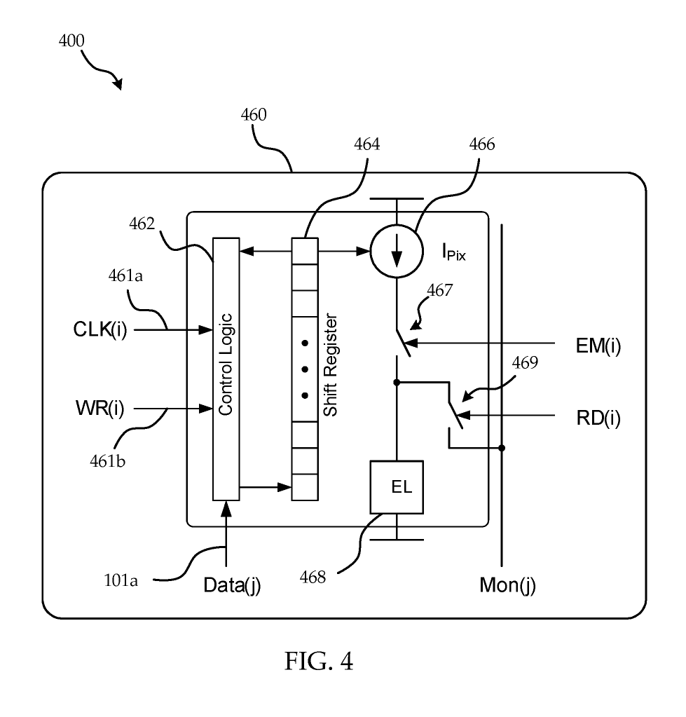

An example implementation of in-pixel driving is illustrated in FIG. 4. A programmable current source 466 (I_{Pix}) provides the driving current for the light-emitting device 468 (EL).

An EM (emission) switch 467 can be used to disconnect the pixel driver from the emissive device 468. Also, a switchable RD (read) signal path 469 provides a signal path to steer the pixel current/charge towards the ROC 114. This signal can be shared with other signals in the pixel, or the controller 462 can control this signal based on the operation mode of the pixel and status of other signals.

In case the grey scale signal is defined by the strength of the output current, the grayscale bits stored in the shift register 464 selects different strengths for the output current. In this case, the current source 466 has different elements with different output current strengths, and different combinations of these current levels are applied to the emissive device 468 according to the data stored in the shift register 464. Similar methods can be applied to a voltage-based driver 166.

In another case, the current source 466 has a fixed output. In this case, the gray scales are defined based on the time the pixel is ON which is controlled by the data stored in the shift register 464. In one case, the data stored in shift register 464 is compared with a counter value. When the two values are the same the pixel current is off (or the current source is disconnected from the emissive device; or its current is redirected to another route). It is worth mentioning that one can do the reverse of the aforementioned operations without affecting the pixel performance. In one example, with an appropriate data and counter, when the data in the shift register of the pixel is the same as the counter value, the pixel turns ON instead of turning OFF. Here the counter can be non-linear to accommodate the non-linear gamma curves. For example, it counts faster at lower grayscales and slows down as greyscale value increases. The speed of the counter can be function of the gamma curve. In another case, the output of shift register 464 is connected to the pixel driver 466 (this signal can either enable/disable the current source, or connect/disconnect the current source from the emissive device). Every clock shifts the value of the shift-register 464. As a result, depending on the value of every bit in the shift register, the pixel driver status can be different. The period of the clocks can be different based on the weight of its corresponding bits in the gamma curve. The shift register can also be a rotating shift register. In this case, the bit that is shifted out is shifted back to the pixel from the other side. As a result, the value programmed in the shift register is preserved and so panel refresh can be stopped without losing the content. This can save power consumption associated with display programming for each frame.

In all inventions and examples in this document no matter what type of signals are used for demonstrations, the clocks and signals can be either active high or active low. Also they can be at active value during the entire active period or just initiate a transition edge (edge active). In this case, they can be active at negative or positive edge or both edges.

In addition, one can use a dynamic weight for each bit so that the errors associated with time modulation effects are reduced. For example, in one case, bit0 can have the lowest value and so the last clock will have the period of time associated with that during the frame time. In another case, bit3 can have the lowest value and so the third clock from the last will have the time associated with the lowest bit during the frame time.

In another aspect of this invention, one can use combination of different signal strengths and timing conditions. One example of this case is to have a few output strengths for each pixel. Depending on the condition of the pixel, one of these outputs is used for time modulation. For example, a global signal can identify high brightness mode, and so the highest output strength is used for time modulation driving.

In the case of using a shift register 464 in the pixel for creating a time modulation effect, the time division clock can be passed to each row through a clock shift register at the edge of the panel, with the clock shift register having a similar size as the number of rows or greater. The clock pattern that has the weight of each bit is shifted into the clock shift register after each shift register clock (this clock can be similar to the clock used for creating the select line for each row, which has a period equal to or smaller than the row time). In another example, the clock can be a separate clock. In this case, one can create different time modulation without being limited to the clock period.

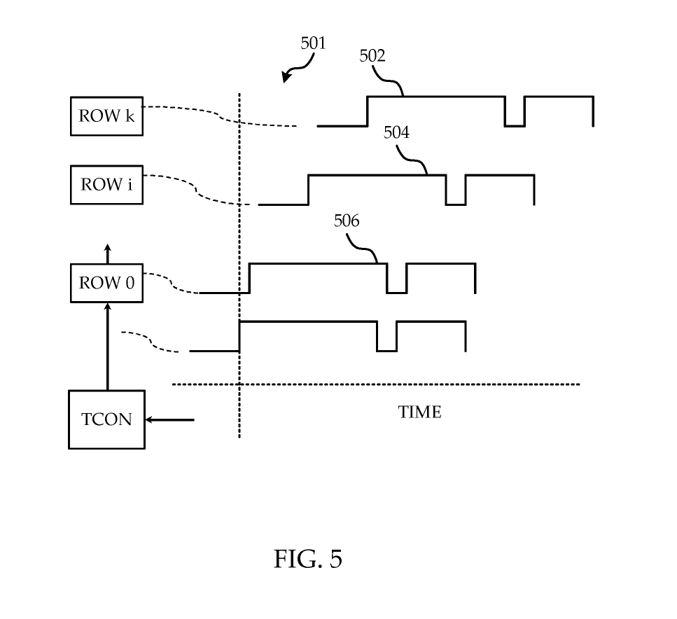

FIG. 5 illustrates one example of this operation. Here, the time-modulation clock is generated with a timing controller or passed by an external circuit to the display. The first part of the clock 501 is not active, which is associated with the pixel programming time. After the row programming is finished, the row can be activated (here the clock is active high but it can be active low as well). Then the clock toggles so that it shifts the value in the pixel shift registers one bit forward. Then it stays active for another period of time. The same situation follows for the next row and the row after. Here, one may need to use multiple shift registers and logic to create different time divisions especially if the number of rows and the number of grayscales do not match.

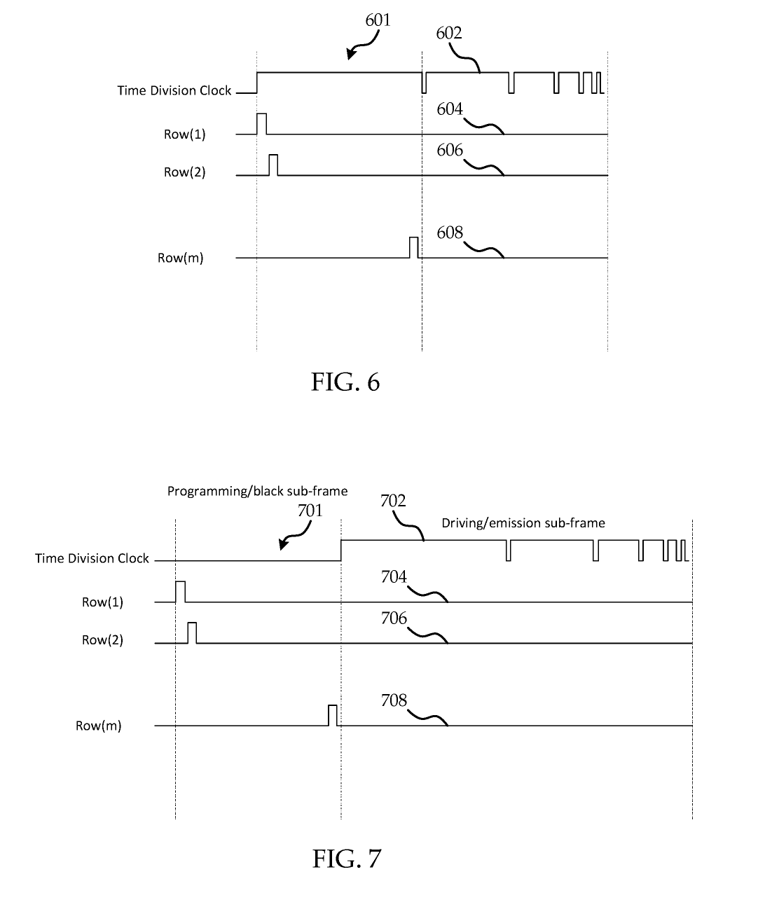

FIG. 6 illustrates another example of the invention. Here, the programming 604, 606, 608 happens during the longer period 601 of the time division clock 602. In one aspect of the invention, the clock for each row can be buffered or another form of buffering can be used. In another aspect of the invention, the clock buffered for each row can be masked by the programming signal of that row so that during the programing of that row the row is not emitting any output.

FIG. 7 illustrates another example of the invention utilizing a time division clock 702. Here, the programming 704, 706, 708 happens during a black sub-frame period 701 where the panel is not emitting any image. In one aspect of the invention, the clock can be buffered for each row or another form of buffering can be used.

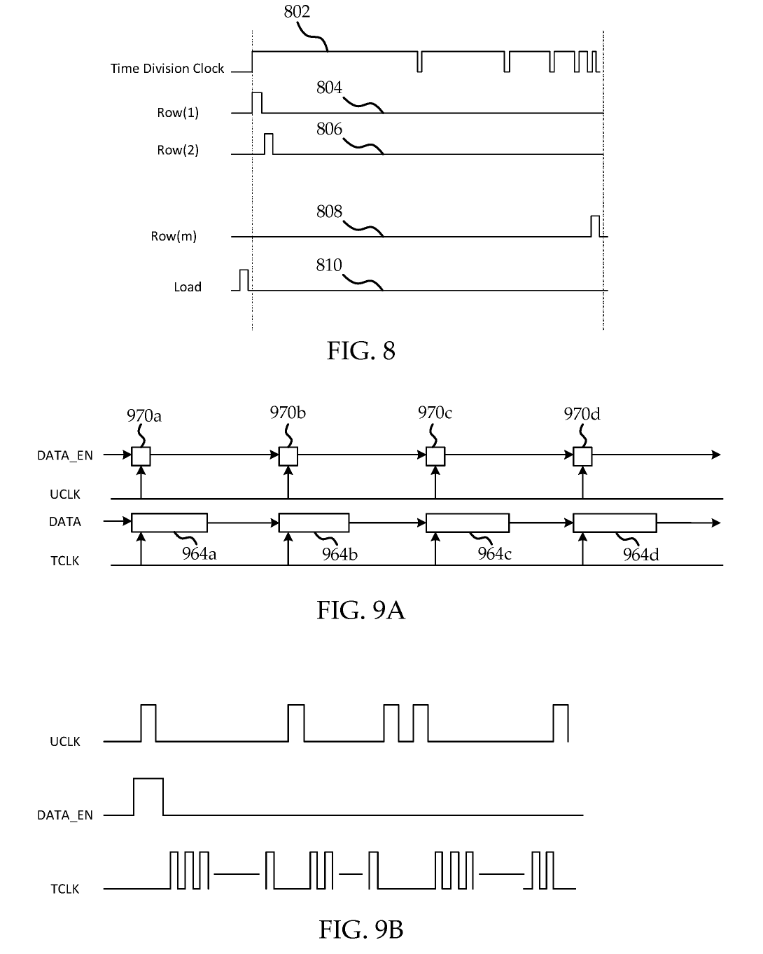

FIG. 8 illustrates another example of the invention utilizing a time division clock 802. Here, the programming 804, 806, 808, 810 happens during normal operation of normal frame. However, the pixels have two data storage elements. While one is being programmed, the other element is used for programming. After the programming, one can either swap the functions of the two storage elements or load the value saved in the programming storage element into the driving storage element. In one aspect of the invention, the clock for each row can be buffered, or another form of buffering can be used. In this case, the entire programming storage element of the panel can be configured as one shift register and so the data for all the pixels can be shifted into it.

### Pixel-Based Addressing

Here, the data of a pixel 150 (or part of its data) can be preserved or alternatively changed. In this case, a signal determines if the content of the data needs to be adjusted or not. This signal can be stored in the storage element 970 for each pixel (or part of pixel) or it can be passed to the pixel by a column path routing. The storage elements 970a, . . . , 970d, for enable signal is demonstrated in FIGS. 9A and 9B.

When using a storage element 970a, . . . , 970d, the enable data can be stored in the pixel in advance or it can be passed along with the data programming. If the data is shifted to the row registers, using a parallel updating of the enable bit can significantly reduce the toggle rate in the programming. Assuming that the enable signal is active high, the data enable is initialized with zero (only once at the beginning of the panel power on). Then, a one is passed to the data enable register 970a, . . . , 970d. It is shifted to the pixel whose data needs to be programmed, and the data of the pixel is changed (only the bits that need to be changed are modified). And this is repeated by shifting the one in the data enable to the next pixel in the row that needs its data to be updated.

### In-Pixel Driving Scheme

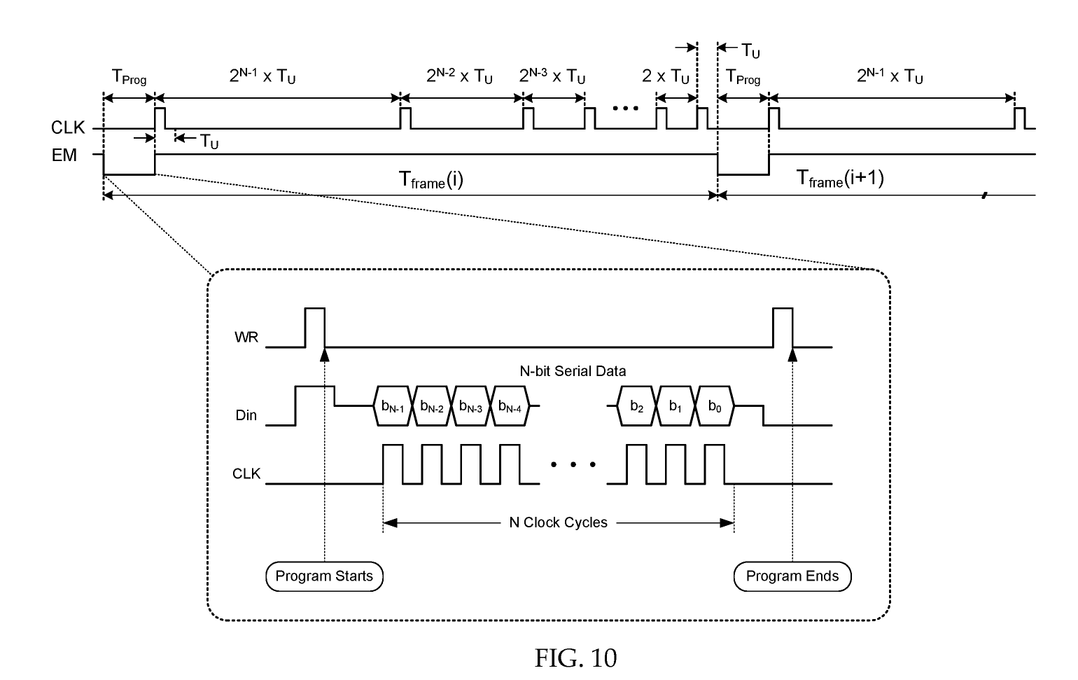

An example of driving scheme is sketched in FIG. 10. In this scheme, the drive current representing the desired output luminance grayscale is quantized by an N-bit digital signal. The N-bit data is programmed and stored in the shift register of FIG. 4. Each bit of the N-bit data (b_{N-1}b_{N-2} . . . b₁b₀) modulates the fixed drive current (I_{Pix}) in a window of time, which is proportional to 2ⁱ×Tᵤ where i is the bit order (0 to N−1) and T^{u} is the unit time window. Accordingly, the effective EL drive current in each frame time is given by:

$${I}_{eff} = {I}_{Pix} \frac{{T}_{u}}{{T}_{Frame}} {\sum }_{i = 0}^{N - 1} {b}_{i} {2}^{i} \qquad ( 1 )$$

Note that:

$${T}_{u} = \frac{{T}_{Frame} - {T}_{prog}}{{2}^{N}} \qquad ( 2 )$$

and hence replacing (2) in (1) results in:

$${I}_{eff} = α \frac{{I}_{Pix}}{{2}^{N}} {\sum }_{i = 0}^{N - 1} {b}_{i} {2}^{i} \qquad ( 3 )$$

where α is a constant given by:

$$α = \frac{{T}_{Frame} - {T}_{prog}}{{T}_{Frame}} \qquad ( 4 )$$

During the program time, the driving current is momentarily deactivated by the EM signal. A logic “1” is asserted on the data line and stored in the controller by a clock pulse on the WR in preparation of a program sequence. An N-bit serial data is then clocked in and programmed in the shift register. Finally, a logic “0” is asserted on the data line and stored in the controller by a clock pulse on the WR in order to halt the program mode.

The described sequence along with the proposed in-pixel driving element provides a unique feature, which enables programming of individual pixels in the selected row. This is particularly useful for power saving when only parts of an image are required to be updated in a given frame.

### Multiplexer-Based Pixel

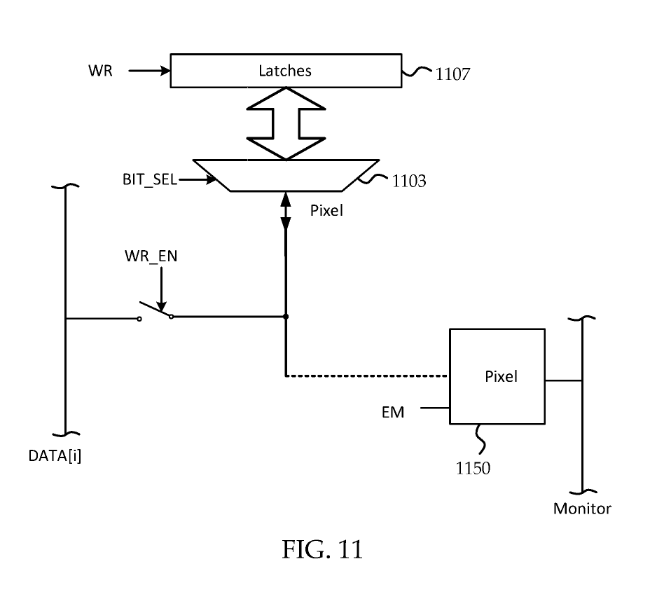

Depending on the content, the toggle for each pixel 1150 can be significant. To reduce the toggle rate in the shift registers, one can use a multiplexer 1103 with weighted select line (BIT SEL) timing, as illustrated in FIG. 11. Here, the programming can happen during shifting the data or one can use the same multiplexer to program the pixel as well. In this case, the storage element can be replaced with simple latches 1107 to reduce the overhead.

### Testing Mode

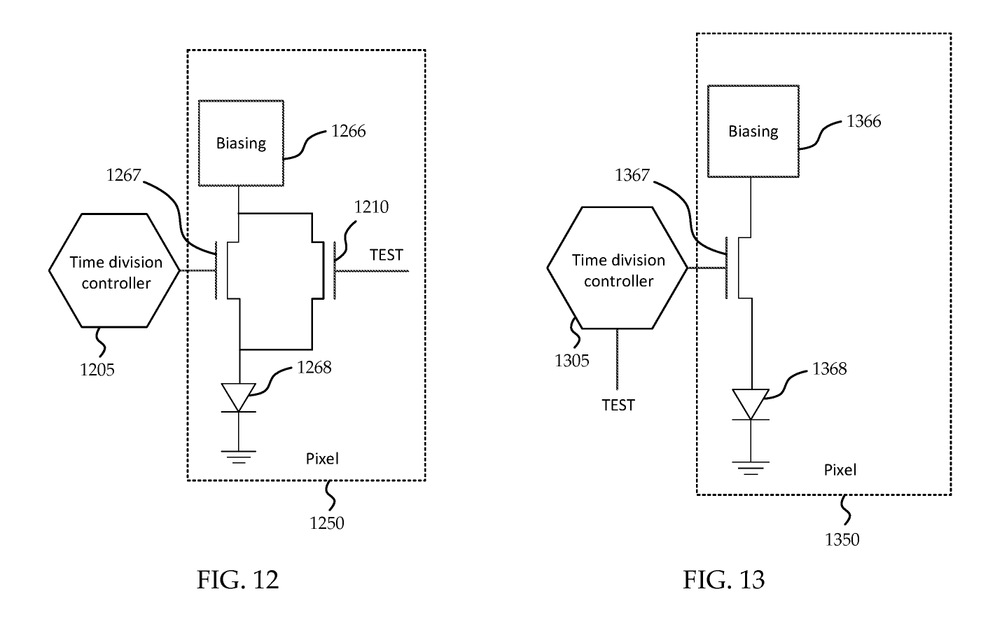

The main challenge with integrated pixel circuit is the initial test of the panel. In FIG. 12, an extra switch 1210 is used to connect the bias section 1266 of the pixel circuit 1250 to the emissive device 1268 during a test mode. Also, the other switch 1267 is connected to a time division controller 1205 that can be implemented by a shift register, multiplexer, counter (or other components), as discussed above.

FIG. 13 illustrates a display test using a time-division controller 131 to connect the pixel in a test mode. The time-division controller 131 connects the biasing circuit 132 to the emissive device 132 through a switch 133 in a special test mode. This test mode can be activated by a specific signal instruction, or by a combination of signals.

### Low Power Mode

In a low-power mode, the number of gray scales is reduced. For programming, either some of the data copied in the pixel shift registers remains unused, or part of the shift registers is removed from the chain so that only the required bits are active. At the same time the number of clock cycles associated with a time division clock can be reduced, although this is not required for functionality of the display. It will only save power consumption. If a counter is used for creating time modulation, the counter size is reduced as well to match the new number of gray scales.

### High Dynamic Range Modes

In a high dynamic range (HDR), the pixels need to provide significantly higher brightness and very dark levels. The main challenge is that the emissive device performance gets compromised if one bias condition is used for the entire operation range of the pixel. For example, if the emissive devices are biased at a high current level and the brightness is controlled with only a time division function, the color of the display may get scarified since the emissive device loses color purity at higher current density. To avoid this, the pixel can offer different biasing points for the emissive device and, depending on the operation range of the pixel, one can select the biasing condition as well. The selection can be globally or for each pixel by programming the biasing condition into the pixel. The programming can be by at least one of analog voltage and digital data.

In one aspect of this invention, there can be different operation points for the pixel circuits that can provide different biasing levels for the emissive devices. In another aspect of the invention, different circuits can be selected for different biasing levels for the emissive devices. Also, one can use a mix of the two cases.

The invention in these documents can be combined together selectively in entirety or partially as needed for an application. The features described for one invention in the document can be applied to the other inventions as well without affecting the performance of the system. The position and orientation of emissive device can be easily changed without affecting the general operation of the pixel circuit. Type of the switches and the transistors can be either p-type, n-type or T-gate without any effect on the pixel circuit.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1-21. (canceled)

22. A display system comprising:
a plurality of pixels, each pixel comprising:
a light-emitting device;
a digital memory for storing data comprising a plurality of bits of greyscale data for display by the pixel; and
a light-emitting device driver for driving the light-emitting device to emit light according to each bit of the greyscale data stored in the digital memory and for a respective different time period for each bit, controlled by a time division clock input to the pixel.

23. The display system of claim 22, wherein the time division clock comprises different clock signal periods each corresponding to a said respective different time period.

24. The display of claim 22, wherein the respective different time period for each bit of the greyscale data corresponds to the weight of the bit of the greyscale data.

25. The display system of claim 24, wherein each weight of each bit of the greyscale data corresponds to the bit order i of the bit, and the time period corresponding to a bit of weight i is proportional to 2ⁱ.

26. The display of claim 22, wherein the digital memory comprises a shift register for storing said data, the shift register having an output coupled to the light-emitting device driver for controlling the driving of the light-emitting device.

27. The display of claim 26, wherein the greyscale data stored in the shift register is shifted by a bit in response to each clock signal of the time division clock input to the pixel.

28. The display system of claim 27, wherein during a frame, for each bit of the greyscale data stored in each pixel, the light-emitting device driver of the pixel drives the light-emitting device of the pixel in one of an on-state and an off-state corresponding to a value of the bit.

29. The display of claim 26, wherein the each pixel of the plurality of pixels is capable of at least a first mode of operation and a second mode of operation, and comprises a controller operative to allow storage of incoming data to the digital memory in the first mode of operation and to preserve data in the digital memory in the second mode of operation.

30. The display system of claim 29, wherein the plurality of pixels are arranged into at least one row, and wherein a plurality of shift registers of pixels in the at least one row are chained together into a shift register chain, wherein incoming data loaded to the shift register chain includes only data for pixels in the first mode of operation, and wherein controllers of pixels in the second mode of operation cause the incoming data to bypass the pixels in the second mode of operation.

31. The display system of claim 29, wherein the digital memory is operative for storing data comprising first greyscale data and second greyscale data, wherein the controller is operative to allow storage of incoming data comprising incoming first greyscale data simultaneously with the pixel's displaying of the second greyscale data.

32. The display system of claim 29, wherein the digital memory of each pixel comprises an enable digital memory for storing a value determining one of the first mode of operation or the second mode of operation for the pixel.

33. The display system of claim 29, wherein the shift register of each pixel comprises a rotating shift register.

34. The display system of claim 22, wherein each bit of the greyscale data are loaded into the digital memory of pixels in a row and displayed prior to a loading of a next bit of the greyscale data.

35. The display system of claim 22, wherein the light-emitting device driver drives the light-emitting device at a driving force based upon at least one of a peak brightness condition and a weight of the bit of the greyscale data being displayed.

36. The display system of claim 22, wherein the light-emitting device driver drives the light-emitting device with use of at least one of a plurality of bias voltages and a plurality of current sources.

37. The display system of claim 22, wherein the light-emitting device driver comprises a multiplexer with weighted select line timing for programming and retrieving data from the digital memory which comprises latches.

38. The display system of claim 22, wherein each pixel is capable of a high dynamic range mode for which the pixel may be driven at one of a plurality of different biasing points in accordance with one of a plurality of biasing conditions for that pixel.

39. The display system of claim 22, wherein the respective different time periods corresponding to the bits of the greyscale data are non-linear in accordance with a non-linear gamma curve.

40. The display system of claim 22, wherein each pixel is capable of a further test mode of operation and comprises a test circuit to control driving of the light-emitting device, wherein when the pixel is in test mode the test circuit drives the light-emitting device independent of the digital memory.

41. The display system of claim 22, wherein each pixel is capable of a low power mode for which the greyscale data for display by the pixel constitutes a subportion of a total greyscale data stored in the digital memory.

42. The display system of claim 22 wherein each respective different time period for each bit of the greyscale data is assigned dynamically.

43. The display system of claim 22, wherein the time division clock is passed from an originating pixel row to a receiving pixel row including a delay to synchronize the time division clock received by the receiving pixel row with an end of programming of the receiving pixel row.
